(19) United States
(12) Patent Application Publication
(10) Pub. No.: US 2024/0238711 A1
(43) Pub. Date: Jul. 18, 2024

(54) ELECTRONIC DEVICE

(71) Applicant: Lenovo Enterprise Solutions (Singapore) Pte. Ltd., Singapore (SG)

(72) Inventors: Chun Hsiang CHOU, Singapore (SG); Yi Lung WU, Singapore (SG); Hsiang Lung YU, Singapore (SG); Mone-Shune TSAI, Singapore (SG)

(21) Appl. No.: 18/410,310

(22) Filed: Jan. 11, 2024

(30) Foreign Application Priority Data
Jan. 18, 2023 (CN) 202310080849.3

(51) Int. Cl. B01D 46/00; B01D 46/44; G01P 5/00

(52) U.S. Cl. CPC B01D 46/0086; B01D 46/444; G01P 5/00; B01D 2273/30; B01D 2279/45

(57) ABSTRACT

An electronic device includes a shell, a fan, a dust filter assembly, a wind speed sensor, and a controller. The shell includes an accommodation space. The fan is arranged in the accommodation space. The dust filter assembly is at least partially arranged at an air opening of the shell and is configured to filter dust. The wind speed sensor is arranged on a side of the air opening of the fan and is configured to detect a first flow rate of air on the side of the air opening of the fan. The controller is electrically connected to the wind speed sensor and is configured to determine whether the dust filter assembly needs to be cleaned based on the first flow rate and a determined flow rate.

### CROSS-REFERENCE TO RELATED APPLICATION

The present disclosure claims priority to Chinese Patent Application No. 2023100808493, filed on Jan. 18, 2023, the entire content of which is incorporated herein by reference.

### TECHNICAL FIELD

The present disclosure relates to an electronic device.

### BACKGROUND

Electronic devices are often used. Often, whether a duster filter needs maintenance in an electronic device needs to be checked manually.

### SUMMARY

A first aspect of the present invention provides an electronic device, including a shell, a fan, a dust filter assembly, a wind speed sensor, and a controller. The shell includes an accommodation space. The fan is arranged in the accommodation space. The dust filter assembly is at least partially arranged at an air opening of the shell and is configured to filter dust. The wind speed sensor is arranged on a side of the air opening of the fan and is configured to detect a first flow rate of air on the side of the air opening of the fan. The controller is electrically connected to the wind speed sensor and is configured to determine whether the dust filter assembly needs to be cleaned based on the first flow rate and a determined flow rate.

### BRIEF DESCRIPTION OF THE DRAWINGS

FIG. 1 illustrates a schematic structural diagram of an electronic device according to some embodiments of the present disclosure.

FIG. 2 illustrates a schematic structural diagram of an electronic device according to some embodiments of the present disclosure.

FIG. 3 illustrates a schematic local structural diagram of an electronic device according to some embodiments of the present disclosure.

FIG. 4 illustrates a schematic local structural diagram of an electronic device according to some embodiments of the present disclosure.

FIG. 5 illustrates a schematic local structural diagram of an electronic device according to some embodiments of the present disclosure.

FIG. 6 illustrates a schematic local structural diagram of an electronic device according to some embodiments of the present disclosure.

FIG. 7 illustrates a schematic local structural diagram of an electronic device according to some embodiments of the present disclosure.

FIG. 8 illustrates a schematic flowchart showing an application method for an electronic device according to some embodiments of the present disclosure.

### REFERENCE NUMERALS

| | | | | | |
|---|---|---|---|---|---|
| 110 | Shell | 111 | Accommodation space | 112 | Air opening |
| 120 | Fan | 130 | Wind speed sensor | 140 | Functional assembly |
| 150 | Circuit board | 151 | Connection through-hole | 152 | Slot |
| 153 | Concave groove | 154 | Concave area | | |

### DETAILED DESCRIPTION OF THE EMBODIMENTS

The technical solution of the present disclosure is described in detail in conjunction with the accompanying drawings and embodiments of the present disclosure.

In embodiments of the present disclosure, unless otherwise specified and limited, the term “connection” should be broadly interpreted. For example, the connection can be an electrical connection or an internal connection between two components. The connection can be a direct connection or an indirect connection through an intermediate medium. Those skilled in the art can understand the specific meaning of the term according to the specific situation.

The terms “first\second\third” used in embodiments of the present disclosure are only used to distinguish similar objects and do not represent a specific order for the objects. In allowable cases, a specific order or sequence of “first\second\third” can be interchanged. The objects distinguished by “first\second\third” can be interchanged in appropriate situations. Thus, embodiments of the present disclosure can be implemented in an order other than the order illustrated or described here.

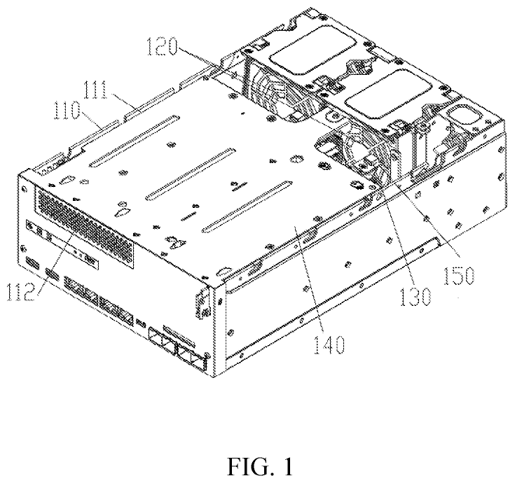

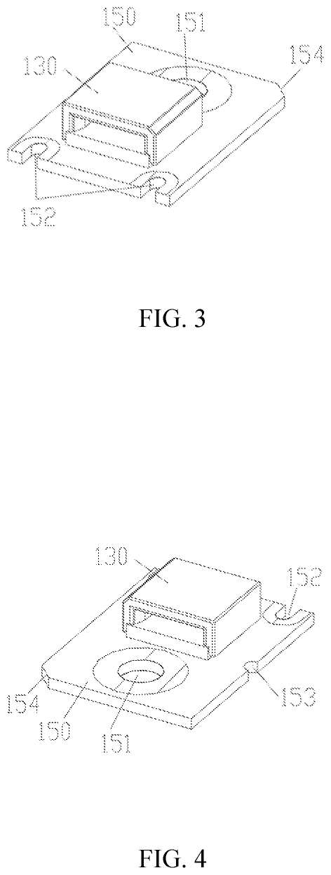

An electronic device of the present disclosure is described in detail in connection with FIG. 1 to FIG. 8.

The electronic device includes a shell 110, a fan 120, a dust filter assembly, a wind speed sensor 130, and a controller. The shell 110 includes an accommodation space 111. The fan 120 is arranged in the accommodation space 111 of the shell 110, and at least a part of the dust filter assembly is arranged at an air opening of the shell 110. The dust filter assembly is configured to filter dust. The wind speed sensor 130 is arranged on a side of the air opening of the fan 120. The wind speed sensor 130 is configured to detect a first flow rate of the air on the side of the air opening of the fan 120. The controller is electrically connected to the wind speed sensor 130. The controller is configured to determine whether the dust filter assembly needs to be cleaned based on the first flow rate and a determined flow rate. Since the wind speed sensor for detecting the first flow rate of the air on the side of the air opening of the fan 120 is arranged on the side of the opening, the controller can automatically determine whether the dust filter assembly needs to be cleaned based on the first flow rate and the determined flow rate. Thus, the user does not need to manually check whether the dust filter assembly needs to be maintained, which greatly improves the adaptability of the electronic device.

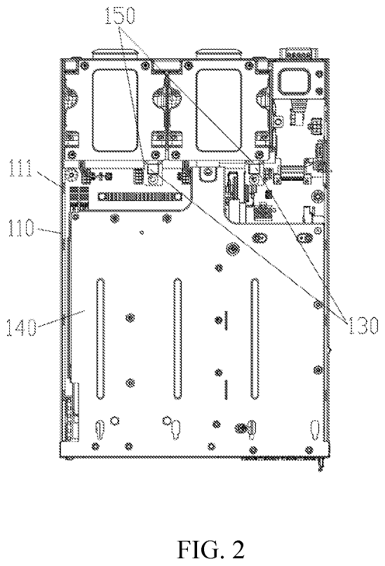

In embodiments of the present disclosure, the structure of the shell 110 is not limited. For example, as shown in FIG. 1 and FIG. 2, the shell 110 can have a cuboid structure. The accommodation space 111 is configured to accommodate a structural member of the electronic device.

The shell 110 includes an air inlet and an air outlet 112. The positions of the air inlet and the air outlet 112 are not limited. For example, the air inlet and the air outlet 112 can be arranged on opposite sides of the shell 110.

In embodiments of the present disclosure, the fan 120 is configured to dissipate the heat of the electronic device, and the fan 120 is also configured to dissipate the heat n of the controller.

The fan 120 can be arranged on a side of the air inlet or the air outlet 112.

A number of fans 120 is not limited. The electronic device can include at least two fans 120. The at least two fans 120 can be spaced within the accommodation space 111. For example, as shown in FIG. 1 and FIG. 2, the electronic device includes two fans 120 arranged at the air outlet.

In embodiments of the present disclosure, the dust filter assembly can be configured to filter dust. The structure of the dust filter assembly is not limited. For example, the dust filter assembly can be a fabric or a metal mesh structure with holes.

The dust filter assembly can be arranged at the air inlet or the air outlet 112.

In embodiments of the present disclosure, the wind speed sensor 130 can be configured to detect the first flow rate of the air on the side of the air opening of the fan 120. When dust accumulates on the dust filter assembly, the first flow rate can be smaller due to the blockage of the dust. When dust on the dust filter assembly is relatively few, the first flow rate can be larger.

The wind speed sensor 130 can be a mechanical wind speed sensor 130, an ultrasonic wind speed sensor 130, etc.

The wind speed sensor 130 can be arranged at the air inlet or the air outlet 112.

A number of wind speed sensors 130 is not limited. For example, the electronic device can include at least two fans 120 and at least two wind speed sensors 130. The at least two wind speed sensors 130 can be correspondingly arranged at the air openings of the at least two fans 120. The at least two wind speed sensors 130 can be configured to detect the first flow rate of the air on the side of the air openings of the at least two fans 120. For example, as shown in FIG. 1 and FIG. 2, the electronic device includes two fans 120 arranged at the air openings. The two wind speed sensors 130 are correspondingly arranged at the air openings of the two fans 120.

In embodiments of the present disclosure, the method of the controller determining whether the dust filter assembly needs to be cleaned based on the first flow rate and the determined flow rate is not limited. For example, when the first flow rate is smaller than the determined flow rate, the controller can determine that the dust filter assembly needs to be cleaned. When the first flow rate is greater than or equal to the determined flow rate, the controller can determine that the dust filter assembly does not need to be cleaned.

The determined flow rate can be a factory flow rate of the electronic device. The determined flow rate can be stored in the electronic device. The determined flow rate can also be a flow rate determined by the controller based on the structural arrangement of the electronic device.

For example, after the electronic device is delivered, the user can add or remove a structural member in the accommodation space 111 as needed. After the structural arrangement of the electronic device is determined, the structural arrangement within the accommodation space 111 can be also determined. Then, when the electronic device is powered on, since there is no dust inside the electronic device, the wind speed sensor 130 can detect a maximum flow rate of the electronic device. The determined flow rate can be 70% or 60% of the maximum flow rate.

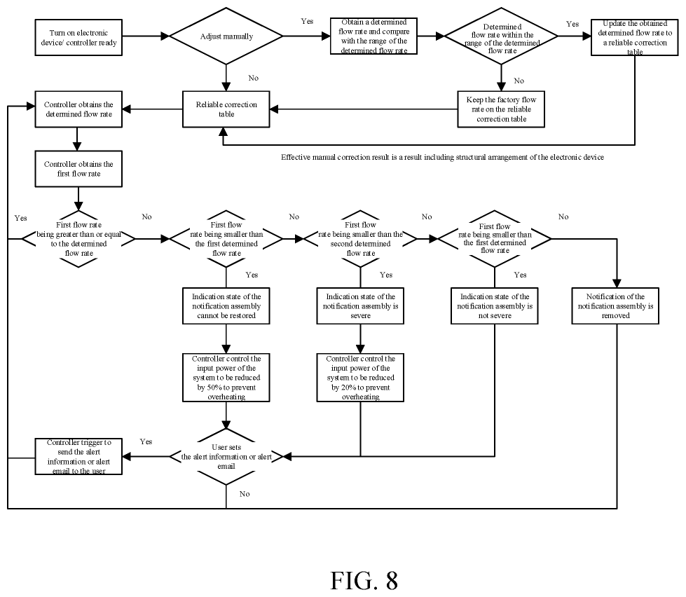

The electronic device can store a range for the determined flow rate. If the controller determines that the flow rate is not within the range of the determined flow rate based on the structural arrangement of the electronic device, the electronic device determines the determined flow rate as the factory flow rate by default as shown in the flowchart of FIG. 8. The range of the determined flow rate can be ±15% of the factory flow rate.

In embodiments of the present disclosure, the electronic device can further include a notification assembly. The notification assembly can be arranged at the shell 110. The notification assembly can be electrically connected to the controller. When determining that the first flow rate is smaller than the determined flow rate, the controller can be further configured to control the notification assembly to notify the user to replace or clean the dust filter assembly.

The structure of the notification assembly is not limited. For example, the notification assembly can include an indicator light. The controller can be further configured to control the indicator light to be on, change color, or flash when determining that the first flow rate is smaller than the determined flow rate.

In some other embodiments, when determining that the first flow rate is smaller than the determined flow rate, the controller can be configured to issue alert information or an alert email to timely notify the user to replace or clean the dust filter assembly. The user can set whether the alert information or the alert email needs to be issued as needed.

When determining that the first flow rate is smaller than the determined flow rate, the controller can control the notification assembly for notification and send the alert information or alert email.

In embodiments of the present disclosure, the electronic device can further include a Field Programmable Gate Array (FPGA) chip. The FPGA chip can be electrically connected to the wind speed sensor 130 and the controller. The FPGA chip can be configured to increase the transmission speed between the controller and the wind speed sensor 130. Thus, the controller can quickly obtain the first flow rate from the wind speed sensor 130. In addition, as shown in FIG. 6, the FPGA chip can also be electrically connected to the fan 120. The FPGA can be further configured to increase the transmission speed between the controller and the fan 120. Thus, the controller can quickly obtain and control the rotation speed of the fan 120. As shown in FIG. 7, the electronic device does not include an FPGA chip, and the controller is electrically connected to the fan 120 and the wind speed sensor 130.

In some embodiments, as shown in FIG. 1 and FIG. 2, the electronic device further includes a circuit board 150. The circuit board 150 is arranged within the accommodation space 111. The wind speed sensor 130 is arranged on the circuit board 150. Then, the circuit board 150 can only have the wind speed sensor 130 without other electronic elements. Thus, the circuit board 150 can be small and can be flexibly arranged. Even in a small space, the wind speed sensor 130 can be also arranged.

In some embodiments, as shown in FIG. 1 and FIG. 2, the electronic device further also includes a functional assembly. The functional assembly is arranged within the accommodation space 111. The circuit board 150 is arranged between the fan 120 and the functional assembly. Since the volume of the circuit board 150 is relatively small, the circuit board 150 can be arranged in the small space between the fan 120 and the functional assembly, which facilitates the wind speed sensor 130 to accurately detect the first flow rate of the air on the side of the air opening of the fan 120.

The structure of the functional assembly is not limited. For example, the functional assembly can include memory.

In some embodiments, the structure of the circuit board 150 is not limited. For example, as shown in FIG. 1 and FIG. 2, the circuit board 150 is in a cuboid shape. The circuit board 150 can also have an irregular shape.

The fixation of the circuit board 150 is not limited. For example, a center part of the circuit board 150 can have a connection through-hole 151. The circuit board 150 can be fastened and connected through the connection through-hole 151. The electronic device can also include a screw. The screw can pass through the connection through-hole 151 and be connected to the shell 110. For example, at least two hooks can be arranged within the accommodation space 111. The at least two hooks can be arranged around the circuit board 150.

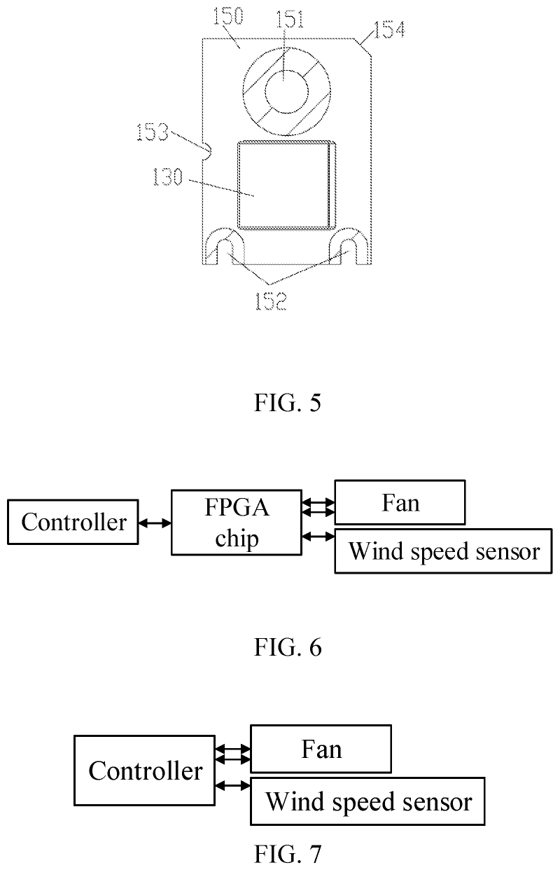

As shown in FIG. 4 and FIG. 5, a first edge of the circuit board 150 includes a slot 152. A protrusion is arranged in the accommodation space 111. By engaging the protrusion with the slot 152, the circuit board 150 can be positioned in the accommodation space 111 to facilitate the fixation and installation of the circuit board 150.

A number of slots 152 is not limited. For example, as shown in FIG. 4 and FIG. 5, the first edge of the circuit board 150 has two slots 152 spaced apart. In some embodiments, the two slots 152 can also be arranged on different edges of the circuit board 150.

An anti-misplacement structure can also be arranged at the peripheral side of the circuit board 150. The structure of the anti-misplacement structure is not limited. For example, as shown in FIG. 4 and FIG. 5, the anti-misplacement structure includes a concave groove 153 arranged at the edge of the circuit board 150. For another example, as shown in FIG. 4 and FIG. 5, the anti-misplacement structure also includes a concave area 154 arranged at a corner of the circuit board 150.

In some embodiments of the present disclosure, the controller can be further configured to determine the input power of the electronic device based on the first flow rate and the determined flow rate to prevent the electronic device from becoming too hot and affecting the service life of the electronic device due to the dust cumulated at the dust filter assembly. The controller can timely control the input power of the electronic device to prevent the electronic device from being overheated.

In some embodiments, the method of the controller determining the input power of the electronic device based on the first flow rate and the determined flow rate is not limited. For example, when determining that the first flow rate is smaller than the determined flow rate, the controller can be further configured to control the input power of the electronic device to be reduced to reduce the heat generated by the electronic device. When determining that the first flow rate is greater than or equal to the determined flow rate, the controller can be further configured to control the input power of the electronic device unchanged.

The determined flow rate can be a flow rate or at least two flow rates. When the determined flow rate includes the at least two flow rates, the controller can provide different instructions based on different determined flow rates.

For example, the determined flow rate can include a first determined flow rate and a second determined flow rate. The first determined flow rate can be greater than the second determined flow rate.

When determining that the first flow rate is smaller than the first determined flow rate, the controller can be further configured to control the notification assembly to notify the user to replace or clean the dust filter assembly.

When determining that the first flow rate is smaller than the first determined flow rate, the controller can be further configured to send the alert information or the alert email to timely notify the user to replace or clean the dust filter assembly.

When determining that the first flow rate is smaller than the first determined flow rate, the controller can be further configured to control the notification assembly for notification and send the alert information or the alert email.

If the user replaces or cleans the dust filter assembly, when determining that the first flow rate is greater or equal to the first determined flow rate, the controller can be configured to control the notification assembly to stop notification and stop sending the alert information or the alert email. In some other embodiments, the user can also turn off the notification assembly. Thus, the notification assembly may no longer notify.

If the user does not replace or clean the dust filter assembly, the heat dissipation of the electronic device can become weaker and weaker. When determining that the first flow rate is smaller than the second determined flow rate, the controller can be further configured to control the input power of the electronic device to be reduced. When determining that the first flow rate is greater than or equal to the second determined flow rate, the controller can control the input power of the electronic device unchanged.

For example, the determined flow rate can include a first determined flow rate, a second determined flow rate, and a third determined flow rate. The first determined flow rate is greater than the second determined flow rate, and the second determined flow rate is greater than the third determined flow rate.

When determining that the first flow rate is smaller than the first determined flow rate, the controller can be further configured to control the notification assembly to notify the user to replace or clean the dust filter assembly.

When determining that the first flow rate is smaller than the first determined flow rate, the controller can be further configured to send the alert information or the alert email to timely notify the user to replace or clean the dust filter assembly.

When determining that the first flow rate is smaller than the first determined flow rate, the controller can be further configured to control the notification assembly for notification and send the alert information or the alert email.

If the user replaces or cleans the dust filter assembly, the first flow rate can be greater than or equal to the first determined flow rate. When determining that the first flow rate is greater or equal to the first determined flow rate, the controller can be configured to control the notification assembly to stop notification and stop sending the alert information or the alert email. In some other embodiments, the user can also turn off the notification assembly. Thus, the notification assembly may no longer notify.

If the user does not replace or clean the dust filter assembly, the heat dissipation of the electronic device can become weaker and weaker. When determining that the first flow rate is smaller than the second determined flow rate, the controller can be further configured to control the input power of the electronic device to be reduced for a first determined value. The user can feel that the electronic device slows down, and the user can clean the dust at the dust filter assembly. After cleaning the dust, the first flow rate can be greater than or equal to the first determined flow rate. When determining that the first flow rate is greater than or equal to the first determined flow rate, the controller can be further configured to control the notification assembly to stop notification and stop sending the alert information or the alert email.

When determining that the first flow rate is smaller than the third determined flow rate, the controller can be further configured to control the input power of the electronic device to be reduced for a second determined value. When the first flow rate is smaller than the second determined flow rate, and the user does not clean the dust, the heat dissipation of the electronic device can become poorer and poorer, and the user can feel that the electronic device is slower. Then, the user needs to be notified to clean the dust at the dust filter assembly as quickly as possible. After cleaning the dust, the first flow rate can be greater than or equal to the first determined flow rate. When determining that the first flow rate is greater than the first determined flow rate, the controller can be further configured to control the notification assembly to stop notification and stop sending the alert information or the alert email.

The first determined value can be smaller than the second determined value. The first determined value and the second determined value are not limited. For example, the first determined value can be 20% of the input power of the electronic device, and the second determined value can be 50% of the input power of the electronic device.

As shown in FIG. 8, the controller is also configured to control the notification assembly to display different states based on the first flow rate. For example, the notification assembly can include an indicator light. When determining that the first flow rate is smaller than the first determined flow rate, the controller can be further configured to control the indicator light to light green to indicate that the state of the dust filter assembly is not severe, and the indicator light can be turned off. When determining that the first flow rate is smaller than the second determined flow rate, the controller can be configured to control the indicator light to light yellow to indicate that the state of the dust filter assembly is severe, and the indicator light can be turned off. When determining that the first flow rate is smaller than the third determined flow rate, the controller can be configured to control the indicator light to light red to indicate that the state of the dust filter assembly is severe, and the indicator light cannot be turned off.

The above are only some embodiments of the present disclosure. However, the scope of the present disclosure is not limited here. Those skilled in the art can easily think of modifications or replacements to embodiments of the present disclosure. These modifications and replacements are within the scope of the present disclosure. The scope of the present disclosure is subject to the scope of the claims.

What is claimed is:

1. An electronic device comprising:
a shell including an accommodation space;
a fan arranged in the accommodation space;
a dust filter assembly at least partially arranged at an air opening of the shell and configured to filter dust;
a wind speed sensor arranged on a side of the air opening of the fan and configured to detect a first flow rate of air on the side of the air opening of the fan; and
a controller electrically connected to the wind speed sensor and configured to determine whether the dust filter assembly needs to be cleaned based on the first flow rate and a determined flow rate.

2. The electronic device according to claim 1, further comprising:
a functional assembly arranged within the accommodation space;
a circuit board arranged between the fan and the functional assembly, the wind speed sensor being arranged located on the circuit board.

3. The electronic device according to claim 2, wherein:
the circuit board is in a cuboid shape, a connection through-hole is arranged at a center part of the circuit board, and a slot is arranged at a first edge of the circuit board; and
a protrusion is arranged in the accommodation space and is engaged with the slot, and the circuit board is fastened and connected through the connection through-hole.

4. The electronic device according to claim 1, further comprising:
an FPGA chip electrically connected to the wind speed sensor and the controller and configured to improve a transmission speed between the controller and the wind speed sensor.

5. The electronic device according to claim 1, wherein the controller is further configured to determine input power of the electronic device based on the first flow rate and the determined flow rate.

6. The electronic device according to claim 1, further comprising:
a notification assembly arranged at the shell and configured to be connected to the controller;
when determining that the first flow rate is smaller than a first determined flow rate, the controller is further configured to:
control the notification assembly for notification; and/or
send alert information or an alert email.

7. The electronic device according to claim 1, wherein when determining that the first flow rate is smaller than a second determined flow rate, the controller is configured to control input power of the electronic device to be reduced.

8. The electronic device according to claim 7, wherein:
when determining that the first flow rate is smaller than the second determined flow rate, the controller is configured to control the input power of the electronic device to be reduced for a first determined value;
when determining that the first flow rate is smaller than a third determined flow rate, the controller is configured to control the input power of the electronic device to be reduced for a second determined value; and
the second determined flow rate is greater than the third determined flow rate, and the first determined value is smaller than the second determined value.

9. The electronic device according to claim 1, wherein the determined flow rate is a factory flow rate of the electronic device, or the set flow rate is determined by the controller based on structural arrangement of the electronic device.

10. The electronic device according to claim 1, further comprising:
at least two fans spaced apart in the accommodation space; and
at least two wind speed sensors arranged correspondingly at air openings of the at least two fans and configured to detect first flow rates of the air on sides of the air openings of the at least two fans.
